(19) United States
(12) Patent Application Publication
(10) Pub. No.: US 2021/0386191 A1
(43) Pub. Date: Dec. 16, 2021

(54) ELECTRIC TOOTHBRUSH

(71) Applicant: THUMBS UP INNOVATIONS TECHNOLOGY CO., LTD., ZHUHAI (CN)

(72) Inventors: Lilin Xu, Zhuhai (CN); Jiacheng Huang, Zhuhai (CN); Yubin Li, Zhuhai (CN); Xiu Zou, Zhuhai (CN); Zhidong Wang, Zhuhai (CH); Yuqiang Zhao, Zhuhai (CN); Lei Zhang, Zhuhai (CN); Zhihui Yang, Zhuhai (CN)

(21) Appl. No.: 17/000,095

(22) Filed: Aug. 21, 2020

(30) Foreign Application Priority Data
Jun. 16, 2020 (CN) 202021115323.2

(51) Int. Cl. A46B 15/00; A46B 13/02; A46B 5/00; A61C 17/22; A61C 17/20

(52) U.S. Cl. CPC A46B 15/0012; A46B 15/0044; A46B 13/02; A46B 2200/1066; A61C 17/221; A61C 17/20; A46B 5/0037

(57) ABSTRACT

The present disclosure provides an electric toothbrush including a driving module, a connection shaft, a battery supporter, a support cover, a print circuit board and a switch. The driving module includes a driving element, a driving element supporter, a reset elastic element and a stress element. The connection shaft passes through the driving element supporter and the battery supporter. The driving element is used to drive the driving module to rotate from a starting position to a triggering position and make the reset elastic element generate elastic deformation. In the starting position, the driving element supporter is separated from the switch, and the switch is in an OFF state. In the triggering position, the driving element supporter contacts the switch and the switch is in an ON state, and the driving module rotates to the starting position with a reset force of the elastic deformation of the elastic element.

### CROSS-REFERENCE TO RELATED APPLICATIONS

This application claims priority of Chinese Patent Application No. 202021115323.2, entitled “AN ELECTRIC TOOTHBRUSH” filed on Jun. 16, 2020, the entire contents of which are incorporated by reference herein.

### FIELD OF THE INVENTION

The present disclosure relates to household electrical appliances technology field, and specifically to an electric toothbrush.

### BACKGROUND OF THE INVENTION

Electric toothbrushes have become an important part of oral health care at home and abroad. A brush head of an electric toothbrush vibrates in a high frequency through a motor to decompose toothpaste into foam and then cleans gaps between teeth by the foam. At the same time, the teeth are rubbed by the brush head in the high frequency, so as to achieve the effect of whitening teeth and cleaning the mouth. In the process of using the electric toothbrush, if a brushing force of the brush head is too small, cleaning efficiency maybe low and cleaning effect maybe poor. If the brushing force is too big, it is easy to damage gums of the teeth. Therefore, it is very important to control the brushing force of the electric toothbrush.

When the brushing force of the existing electric toothbrush exceeds a preset value during brushing, the motor can be turned to contact a switch and make the switch in a closed state, and thus, the brushing force is controlled by the motor. However, due to the contact between the switch and a switch contact element is rigid, the switch may not reset when the brushing force decreases or disappears during brushing, then the normal use of the electric toothbrush may be affected.

### SUMMARY OF THE INVENTION

In order to overcome the disadvantage of the existing electric toothbrush, the present disclosure provides an electric toothbrush having a switch able to reset automatically.

The present disclosure adopts the following technical solution: an electric toothbrush including a driving element, a driving element supporter, a reset elastic element, a stress element, a first damping element, a second damping element, a connection shaft, a battery supporter, a support cover, a print circuit board, a prompter and a switch, the driving element, the driving element supporter, the reset elastic element, the first damping element, the stress element and the second damping element constituting a driving module, the connection shaft passing through the driving element supporter and the battery supporter to form a rotation portion such that the driving module and battery supporter have a rotation connection, the elastic reset element and the switch being disposed on the driving element supporter, the support cover being disposed above the battery supporter and is used to make the elastic reset element generate elastic deformation, the switch, the prompter, and the driving element being electrically connected to the print circuit board, the driving element used to drive the driving module to rotate from a starting position to a triggering position about the rotation portion and make the reset elastic element generate elastic deformation, in the starting position, the driving element supporter separated from the switch, and the switch being in an OFF state, in the triggering position, the driving element supporter contacting the switch, and the switch being in an ON state, and the driving module rotating from the triggering position to the starting position about the rotation portion with a reset force of the elastic deformation of the elastic element.

Further, the driving element and the battery supporter has the rotation connection by the connection shaft, the elastic reset element is fixed on a back part of the driving element supporter, and the support cover is fixed on the battery supporter and used to make the elastic reset element generate the elastic deformation.

Further, the connection shaft passes through a bottom part of the driving element supporter and a side surface of the battery supporter to form the rotation portion such that the driving module is able to rotate about the connection shaft.

Further, an end of the stress element is located around a back part of the first damping element, and the other end of the stress element is inserted into a round groove of the battery supporter and contacts the battery supporter.

Further, the first damping element is located around a back part of the driving element and disposed between the first damping element and the battery supporter, and the second damping element are located at a front part of the diving element.

Further, the driving element, supporter includes a contact protrusion corresponding to the switch, and the contact protrusion contacts the switch.

Further, the connection shaft is made of hard materials.

Further, the electric toothbrush further includes a battery, and the battery is disposed at a casing of the battery supporter and is used to power the driving element, the prompter and the print circuit board.

Further, the prompter is disposed at a front side of the battery supporter and the support cover, the print circuit board is connected to the prompter and is used to control the prompter turn on during the ON state.

The present disclosure also adopts the following technical solution: an electric toothbrush including a driving module, a connection shaft, a battery supporter, a support cover, a print circuit board and a switch, the driving module including a driving element, a driving element supporter, a reset elastic element and a stress element, the connection shaft passing through the driving element supporter and the battery supporter to form a rotation portion such that the driving module and the battery supporter have a rotation connection, the elastic reset element and the switch being disposed on the driving element supporter, the support cover being disposed above the battery supporter and used to make the elastic reset element generate elastic deformation, the switch and the driving element being electrically connected to the print circuit board, the driving element used to drive the driving module to rotate from a starting position to a triggering position of the switch about the rotation portion and make the reset elastic element generate elastic deformation during the rotating, in the starting position, the driving element supporter being separated from the switch and the switch being in an OFF state, in the triggering position, the driving element supporter contacting the switch and the switch being in an ON state, and the driving module rotating from the triggering position to the starting position about the rotation portion with a reset force of the elastic deformation of the elastic element.

Further, the electric toothbrush includes a first damping element disposed at a back part of the driving element and a second damping element disposed at a front part of the diving element, an end of the stress element is located around a back part of the first damping element, and the other end of the stress element inserts into a round groove of the battery supporter and contacts the battery supporter.

Further, the electric toothbrush includes a prompter electrically connected to the print circuit board, when the switch is in the ON state and a brushing force of a brush head to teeth is greater than or equal to a determined value, the print circuit board controls the driving element reduce a rotation speed of the driving element or make the driving element stop rotating and turn on the prompter to prompt user.

Further, when the driving module rotates from the triggering position to the starting position by the reset force of the elastic deformation of the elastic element, the print circuit board controls the driving element rotate in original speed and controls the prompter turn off.

Further, the driving element supporter includes a contact protrusion, in the starting position, the contact protrusion is separated from the switch, and the switch is in the OFF state; and in the triggering position, the contact protrusion of the driving element supporter contacts the switch such that the switch is in the ON state.

Further, the driving element supporter includes a barrel shape groove portion, the elastic reset element is disposed in the barrel shape groove portion and able to deform due to a stress from the support cover.

Further, the elastic reset element is selected from the group of a spring and an elastic rubber ring.

Further, the stress element is selected from the group of a spring and an elastic rubber ring.

Further, the electric toothbrush includes a battery, and the battery is disposed in a casing of the battery supporter and is used to power the driving element, the prompter and the print circuit board.

In present disclosure, when the brushing force of a brush head to teeth is greater than or equal to the determined value, the driving element makes the driving module rotate from the starting position to the triggering position, and at the same time, the reset elastic element generates the elastic deformation. In the triggering position, the contact protrusion of the driving element supporter contacts the switch, and the switch is in the ON state, and at the same time, the print circuit board controls the driving element reduce a rotation speed of the driving element or make the driving element stop rotating and turns on the prompter to prompt the user. When the brushing force of the brush head to teeth decreases or disappears, the driving module rotates from the triggering position to the starting position by the reset force of the elastic deformation of the elastic element. In the starting position, the contact protrusion of the driving element supporter is separated from the switch, and the switch is in an OFF state, and at the same time, the print circuit board controls the driving element rotate in original speed and turns off the prompter. Thus, compare to the rigid contact between the switch and a switch contact element in the existing electric toothbrush, in the electric toothbrush of the present disclosure, the switch can reset automatically by the reset force of the elastic deformation of the elastic element, the normal use of the electric toothbrush may not be affected.

### BRIEF DESCRIPTION OF THE DRAWINGS

For the purpose of a clearer description of the embodiments in this application or technical solutions in prior art, below is a brief introduction of the attached drawings needed to be used in the description of the embodiments or prior art. Apparently, the attached drawings in the following description are only some embodiments indicated in the present application. For ordinary skill in the art, they may obtain other drawings according to these attached drawings without any innovative laboring.

The present disclosure will be further described with reference to the attached drawings and the embodiments hereunder.

FIG. 1 is an explosive view of a driving module of an electric toothbrush according to one embodiment of the present disclosure;

FIG. 2 is a section view of the driving module of the electric toothbrush of FIG. 1 according to the embodiment of the present disclosure;

FIG. 3 is an explosive view of the electric toothbrush according to the embodiment of the present disclosure;

FIG. 4 is a section view of the electric toothbrush according to the embodiment of the present disclosure;

FIG. 5 is an enlarged view of a part A of FIG. 4; and

FIG. 6 is an enlarged view of a part B of FIG. 4.

### DETAILED DESCRIPTION OF THE ILLUSTRATED EMBODIMENT

In order to provide a clear understanding of the objects, features, and advantages of the embodiments, the following are detailed and complete descriptions to the technological solutions adopted in the embodiments. Obviously, the descriptions are part of the whole embodiments. The other embodiments which are not processed creatively by technicians of ordinary skills in the field are under the protection of this disclosure. The same is given with reference to the drawings and specific embodiments. It should be noted that non-conflicting embodiments in the disclosure and the features in the embodiments may be combined with each other without conflict.

In the following description, numerous specific details are set forth in order to provide a full understanding of the disclosure. The disclosure may be practiced otherwise than as described herein. The following specific embodiments are not to limit the scope of the disclosure.

Unless defined otherwise, all technical and scientific terms herein have the same meaning as used in the field of the art as generally understood. The terms used in the disclosure are to describe particular embodiments and are not intended to limit the disclosure.

The disclosure, referencing the accompanying drawings, is illustrated by way of examples and not by way of limitation. It should be noted that references to “an” or “one” embodiment in this disclosure are not necessarily to the same embodiment, and such references mean “at least one.”

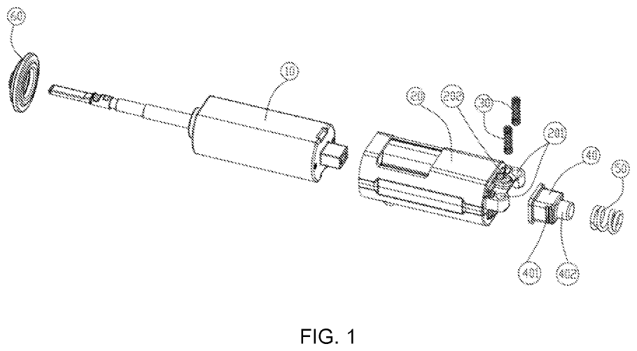

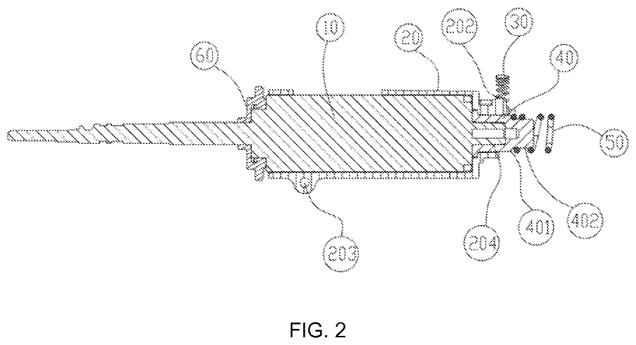

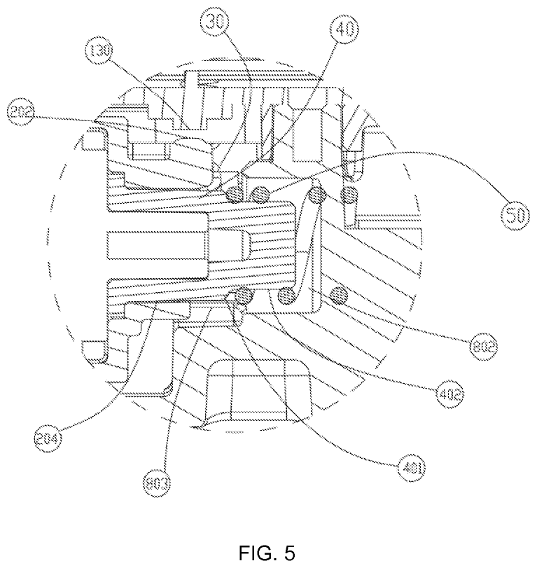

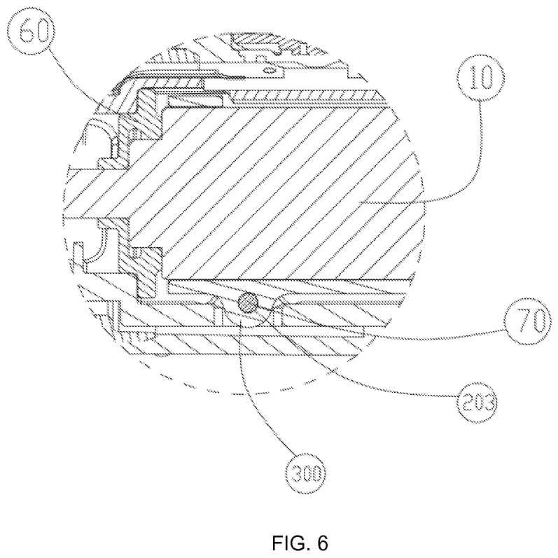

Referring to FIGS. 1-6, the present disclosure provides an electric toothbrush, and the electric toothbrush includes a driving element 10, a driving element supporter 20, a reset elastic element 30, a first damping element 40, a stress element 50, a second damping element 60, a connection shaft 70, a battery supporter 80, a support cover 90, a print circuit board 100, a prompter 110 and a switch 130. The driving element 10, the driving element supporter 20, the reset elastic element 30, the first damping element 40, the stress element 50 and the second damping element 60 constitute a driving module 200 disposed on the battery supporter 80. The connection shaft 70 passes through the driving element supporter 20 and a battery supporter 80 to form a rotation portion 300. The driving module 200 is fixed on the battery supporter 80 by the reset elastic element 30, the first damping element 40, the connection shaft 70, the support cover 90 and the stress element 50. The support cover 90 is disposed above the battery supporter 80 and is able to make the reset elastic element 30 generate elastic deformation. The driving module 200 rotates from a starting position to a triggering position of the switch 130 about the rotation portion 300 and makes the reset elastic element 30 generate the elastic deformation during the rotating. In the starting position, a contact protrusion 202 of the driving element supporter 20 is separated from the switch 130, and the switch 130 is in an OFF state. In the triggering position, the contact protrusion 202 of the driving element supporter 20 contacts the switch 130, and the switch 130 is in an ON state, and at the same time, the driving module 200 rotates from the triggering position to the starting position with a reset force of the elastic deformation of the elastic element 30 and controls a turn on state and a turn off state of the prompter 110 to prompt users.

It can be understood, the driving module 200, the battery supporter 80, the connection shaft 70 and the support cover 90 constitute a lever based on the rotation portion 300 as a supporting point. When a brushing force of a brush head 140 to teeth is greater than a determined value, the driving element 10 makes the driving module 200 rotate from the starting position to the triggering position by a force of the brush head 140, and at the same time, the reset elastic element 30 generates the elastic deformation due to the support cover 90. When the brushing force of the brush head 140 to teeth decreases or disappears, the driving module 200 rotates from the triggering position to the starting position by the reset force of the elastic deformation of the elastic element 30 and controls the turn on state and the turn off state of the prompter 110.

Further, the electric toothbrush includes the connection shaft 70, the battery supporter 80 and the support cover 90, the driving module 200 and the battery supporter 80 have a rotation connection through the connection shaft 70, the support cover 90 is fixed above the battery supporter 80, and the battery supporter 80 has a chamber for accommodating a battery 120. A bottom part of the battery supporter 80 has a round hole 801, a round groove 802 and a support portion 803. The connection shaft 70 passes through a round hole 203 of the driving element supporter 20 and the round hole 801 of the battery supporter 80, in order to support the driving element supporter 20 and the battery supporter 80 and make the driving element supporter 20 and the battery supporter 80 have the rotation connection, such that the driving module 200 can rotate about the connection shaft 70.

Further, the connection shaft 70 is made of hard materials including but not limited to stainless steel materials, brass materials, and plastic materials. In the embodiment, the connection shaft 70 is a stainless steel shaft which can not easily deform and has high hardness and a smooth surface without burr.

Further, the driving module 200 includes the driving element 10, the driving element supporter 20 and the elastic reset element 30, the driving element 10 inserts into inside of the driving element supporter 20. The driving element 10 can be an acoustic vibration motor and need to be disposed firmly inside of the driving element supporter 20. The elastic reset element 30 is fixed on the driving element supporter 20. In some detail, the elastic reset element 30 is disposed in a barrel shape groove portion 201 and can deform due to a stress from the support cover 90, such that the elastic reset element 30 have a pressing and fixing function and cannot move. In the embodiment, the elastic reset element 30 is a spring. In other embodiments, the elastic reset element 30 can be an elastic rubber ring. A bottom part of the driving element supporter 20 has a protrusion, and the round hole 203 passes through the protrusion of the driving element supporter 20.

Furthermore, referring to FIGS. 1, 2 and 4, the driving module 200 includes the first damping element 40, the stress element 50 and the second damping element 60, the second damping element 60 is disposed around a front part of the driving element supporter 20, the first damping element 40 is sandwiched between the driving element supporter 20 and the battery supporter 80, and the elastic element is disposed around a back part of first damping element 40. In some detail, referring to FIGS. 1, 4 and 5, the first damping element 40 has a step portion 401 and a connection portion 402, the first damping element 40 partly connects the support portion 803 of the battery supporter 80, and the support portion 803 supports the driving module 200. The stress element is disposed around the connection portion 402, an end of the stress element 50 contacts the step portion 401, and the other end of the stress element 50 inserts into the round groove 802 of the battery supporter 80 and contacts a bottom part of the round groove 802. A distance between the step portion 401 and the bottom part of the round groove 802 is less than a length of the stress element 50, such that the stress element 50 generates an elastic deformation force to achieve supporting, fixing and damping functions. In the embodiment, the stress element 50 is a spring. In other embodiments, the stress element 50 can be an elastic rubber ring. It can be understood, during the rotating of the driving element 30, the first damping element 40 and the second damping element 60 can generate deformation and have damping functions. In the embodiment, the first damping element 40 and the second damping element 60 are rubber elements or silicone elements.

Furthermore, referring to FIGS. 1, 2 and 4, the driving element supporter 20 has the contact protrusion 202 corresponding to the switch 130, the contact protrusion. 202 is used to contract the switch 130 in order to control the OFF state and the ON state of the switch 130. In some detail, the contact protrusion 202 has a half-ball shape, such that the contact protrusion 202 has a simple structure and is easy to make. In addition, the contact between the contact protrusion 202 and the switch 130 is a protruding point contact that can ensure contact reliability of the contact protrusion 202 and the switch 130.

Furthermore, the switch 130 is fixed on the print circuit board 100 and corresponding to the contact protrusion 202, and the print circuit board 100 is electrically connected to the prompter 110.

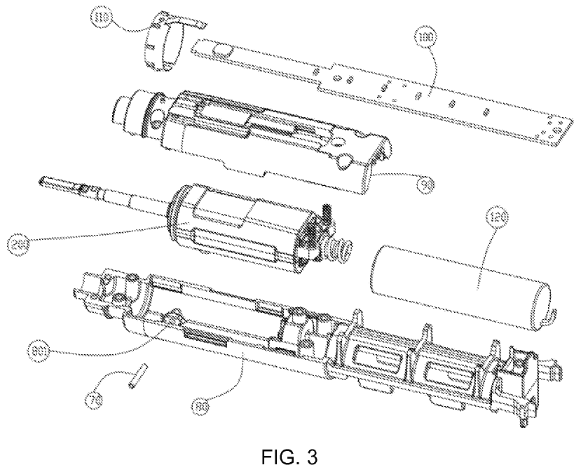

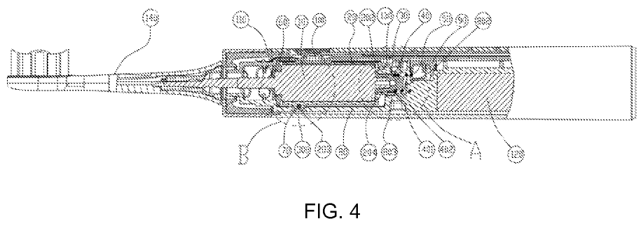

Furthermore, referring to FIGS. 3 and 4, the electric toothbrush includes the battery 120, and the battery 120 is disposed in a casing of the battery supporter 80, the battery 120 is used to power the driving element 20, the prompter 110 and the print circuit board 100.

Furthermore, the prompter 110 can be a round light emitting diode and disposed a front side of the battery supporter 80 and the support cover 90. The switch 130 controls the light emitting diode of the prompter 110 emit a light signal in the ON state. It can be understood, the prompter 110 can be a signal light or a buzzer. No matter it is a sound signal or a light signal, it can prompt the users to know the current use state of the electric toothbrush.

In the embodiment, when the brushing force of a brush head 140 to teeth is greater than the determined value, the driving element 10 makes the driving module 200 rotate from the starting position to the triggering position by the force of the brush head 140, and at the same time, the reset elastic element 30 generates the elastic deformation. In the triggering position, the contact protrusion 202 of the driving element supporter 20 contacts the switch 130, and the switch 130 is in the ON state, and at the same time, the print circuit board 100 controls the driving element 20 reduce a rotation speed of the driving element 10 or make the driving element 10 stop rotating and turns on the prompter 110 to prompt the user. When the brushing force of the brush head 140 to teeth decreases or disappears, the driving module 200 rotates from the triggering position to the starting position by the reset force of the elastic deformation of the elastic element 30. In the starting position, the contact protrusion 202 of the driving element supporter 20 is separated from the switch 130, and the switch 130 is in an OFF state, and at the same time, the print circuit board controls the driving element 10 rotate in original speed and turns off the prompter 110. Thus, compare to the rigid contact between the switch and a switch contact element in the existing electric toothbrush, in the electric toothbrush of the present disclosure, the switch 110 can reset automatically by the reset force of the elastic deformation of the elastic element 30, the normal use of the electric toothbrush may not be affected.

Finally, it should be noted that above embodiments are merely used for illustrating the technical solutions of the disclosure, rather than limiting the disclosure; though the disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the disclosure.

What is claimed is:

1. An electric toothbrush, comprising:
a driving element, a driving element supporter, a reset elastic element, a stress element, a first damping element, a second damping element, a connection shaft, a battery supporter, a support cover, a print circuit board, a prompter and a switch;
wherein the driving element, the driving element supporter, the reset elastic element, the first damping element, the stress element and the second damping element constitute a driving module;
the connection shaft passes through the driving element supporter and the battery supporter to form a rotation portion such that the driving module and battery supporter have a rotation connection;
the elastic reset element and the switch are disposed on the driving element supporter;
the support cover is disposed above the battery supporter and is used to make the elastic reset element generate elastic deformation;
the switch, the prompter, and the driving element are electrically connected to the print circuit board;
the driving element is used to drive the driving module to rotate from a starting position to a triggering position about the rotation portion and make the reset elastic element generate elastic deformation;
in the starting position, the driving element supporter is separated from the switch, and the switch is in an OFF state;
in the triggering position, the driving element supporter contacts the switch, and the switch is in an ON state; and
the driving module rotates from the triggering position to the starting position about the rotation portion with a reset force of the elastic deformation of the elastic element.

2. The electric toothbrush according to claim 1, wherein the driving element and the battery supporter has the rotation connection by the connection shaft, the elastic reset element is fixed on a back part of the driving element supporter, and the support cover is fixed on the battery supporter and used to make the elastic reset element generate the elastic deformation.

3. The electric toothbrush according to claim 1, wherein the connection shaft passes through a bottom part of the driving element supporter and a side surface of the battery supporter to form the rotation portion such that the driving module is able to rotate about the connection shaft.

4. The electric toothbrush according to claim 1, wherein an end of the stress element is located around a back part of the first damping element, and the other end of the stress element is inserted into a round groove of the battery supporter and contacts the battery supporter.

5. The electric toothbrush according to claim 1, wherein the first damping element is located around a back part of the driving element and disposed between the first damping element and the battery supporter, and the second damping element are located at a front part of the diving element.

6. The electric toothbrush according to claim 1, wherein the driving element supporter comprises a contact protrusion corresponding to the switch, and the contact protrusion contacts the switch.

7. The electric toothbrush according to claim 1, wherein the connection shaft is made of hard materials.

8. The electric toothbrush according to claim 1, wherein the electric toothbrush further comprises a battery, and the battery is disposed at a casing of the battery supporter and is used to power the driving element, the prompter and the print circuit board.

9. The electric toothbrush according to claim 1, wherein the prompter is disposed at a front side of the battery supporter and the support cover, the print circuit board is connected to the prompter and is used to control the prompter turn on during the ON state.

10. An electric toothbrush, comprising:
a driving module, a connection shaft, a battery supporter, a support cover, a print circuit board and a switch, the driving module comprising a driving element, a driving element supporter, a reset elastic element and a stress element;
wherein the connection shaft passes through the driving element supporter and the battery supporter to form a rotation portion such that the driving module and the battery supporter have a rotation connection;
the elastic reset element and the switch are disposed on the driving element supporter;
the support cover is disposed above the battery supporter and is used to make the elastic reset element generate elastic deformation;
the switch and the driving element are electrically connected to the print circuit board;
the driving element is used to drive the driving module to rotate from a starting position to a triggering position of the switch about the rotation portion and make the reset elastic element generate elastic deformation during the rotating;
in the starting position, the driving element supporter is separated from the switch, and the switch is in an OFF state;
in the triggering position, the driving element supporter contacts the switch and the switch is in an ON state; and
the driving module rotates from the triggering position to the starting position about the rotation portion with a reset force of the elastic deformation of the elastic element.

11. The electric toothbrush according to claim 10, wherein the electric toothbrush further comprises a first damping element disposed at a back part of the driving element and a second damping element disposed at a front part of the diving element, an end of the stress element is located around a back part of the first damping element, and the other end of the stress element inserts into a round groove of the battery supporter and contacts the battery supporter.

12. The electric toothbrush according to claim 10, wherein the electric toothbrush further comprises a prompter electrically connected to the print circuit board, when the switch is in the ON state and a brushing force of a brush head to teeth is greater than or equal to a determined value, the print circuit board controls the driving element reduce a rotation speed of the driving element or make the driving element stop rotating and turn on the prompter to prompt user.

13. The electric toothbrush according to claim 12, wherein when the driving module rotates from the triggering position to the starting position by the reset force of the elastic deformation of the elastic element, the print circuit board controls the driving element rotate in original speed and controls the prompter turn off.

14. The electric toothbrush according to claim 10, wherein:
the driving element supporter comprises a contact protrusion,
in the starting position, the contact protrusion is separated from the switch, and the switch is in the OFF state; and
in the triggering position, the contact protrusion of the driving element supporter contacts the switch such that the switch is in the ON state.

15. The electric toothbrush according to claim 10, wherein the driving element supporter comprises a barrel shape groove portion, the elastic reset element is disposed in the barrel shape groove portion and able to deform due to a stress from the support cover.

16. The electric toothbrush according to claim 10, wherein the elastic reset element is selected from the group of a spring and an elastic rubber ring.

17. The electric toothbrush according to claim 10, wherein the stress element is selected from the group of a spring and an elastic rubber ring.

18. The electric toothbrush according to claim 10, wherein the electric toothbrush further comprises a battery, and the battery is disposed in a casing of the battery supporter and is used to power the driving element, the prompter and the print circuit board.
